(19) United States
(12) Patent Application Publication
(10) Pub. No.: US 2025/0170865 A1
(43) Pub. Date: May 29, 2025

(54) Trailer Jack

(71) Applicant: Brian Dehart, Springfield, PA (US)

(72) Inventor: Brian Dehart, Springfield, PA (US)

(21) Appl. No.: 18/963,150

(22) Filed: Nov. 27, 2024

Related U.S. Application Data
(60) Provisional application No. 63/603,012, filed on Nov. 27, 2023.

(51) Int. Cl. B60D 1/66; B60S 9/18

(52) U.S. Cl. CPC B60D 1/665; B60S 9/18

(57) ABSTRACT

Disclosed is a swivel jack that comprises a central element with a wheel assembly to allow the jack to be transported when installed to a trailer. The central element is made up from multiple columns that are telescopically connected to one another to allow the jack to be raised and lowered. The central element is centrally positioned on a plate which rests on a base. Housed between the plate and the base are ball bearings which give rise to the swivel function of the swivel jack. The swivel jack comes equipped with a brake lock level that when depressed stops the wheel on the jack from rotating preventing movement of the trailer jack.

### FIELD OF THE INVENTION

The present invention relates generally to vehicle hardware. More specifically it is a vehicle trailer attachment with raising, lowering, and locking capabilities.

### BACKGROUND OF THE INVENTION

Trailer jacks are essential components used to stabilize and support trailers when they are not attached to a vehicle. They are designed to assist in hitching and unhitching trailers from vehicles, as well as provide support when the trailer is stationary. These jacks come in various types, each serving a specific purpose and catering to different trailer sizes and weights. Swivel Jacks are among the most popular trailer jacks.

An object of the present invention is to provide a trailer jack that operates by way of ball bearings that allow the jack to rotate 360 degrees in any direction. The presenting invention has a swivel mechanism that allows the jack to be easily rotated and positioned beneath the trailer frame. Factors like trailer size, weight, and the terrain where the trailer will be used should be considered when selecting the appropriate jack.

### BRIEF DESCRIPTION OF THE DRAWINGS

FIG. 1 is a front-right-top perspective view of the invention.

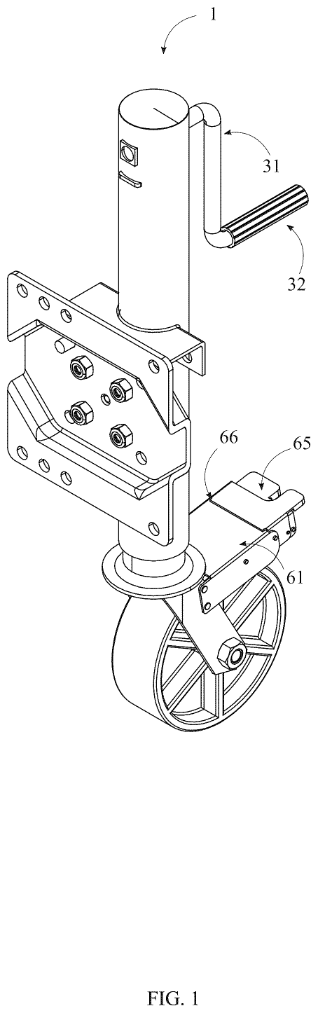

FIG. 2 is a left view of the present invention.

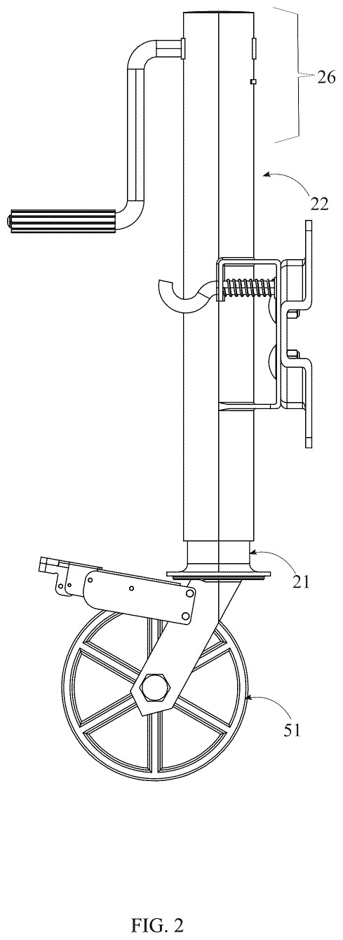

FIG. 3 is a right view of the present invention.

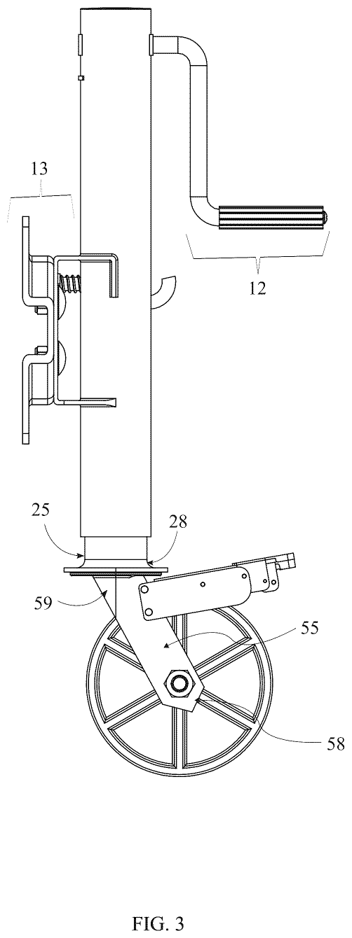

FIG. 4 is a front view of the present invention.

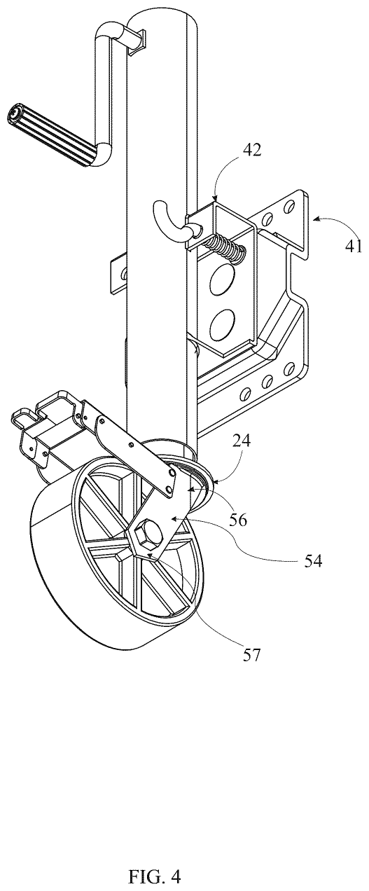

FIG. 5 is a bottom view of the present invention.

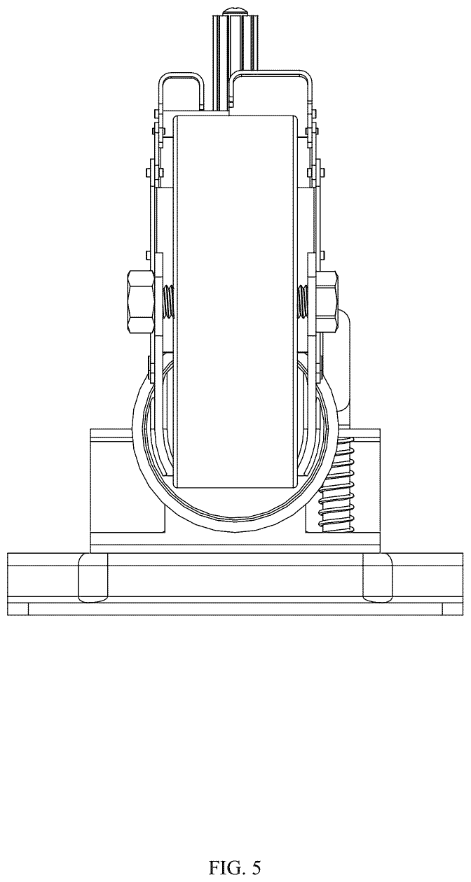

FIG. 6 is a top view of the locking wheel.

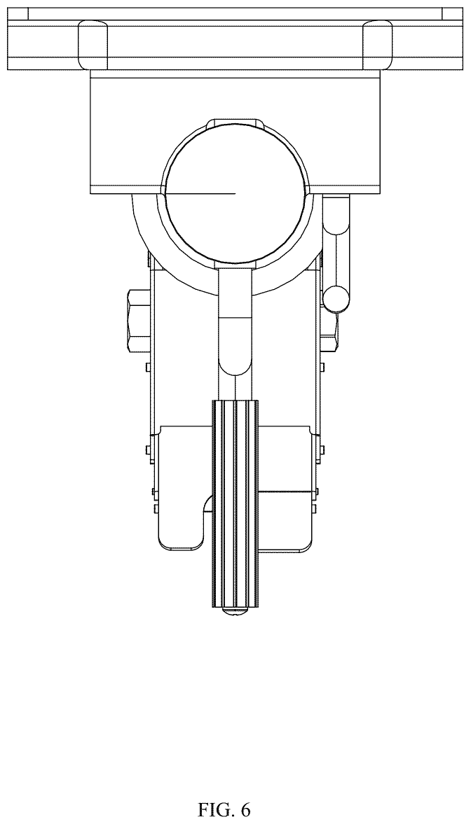

FIG. 7 is a top-rear-left view of the present invention.

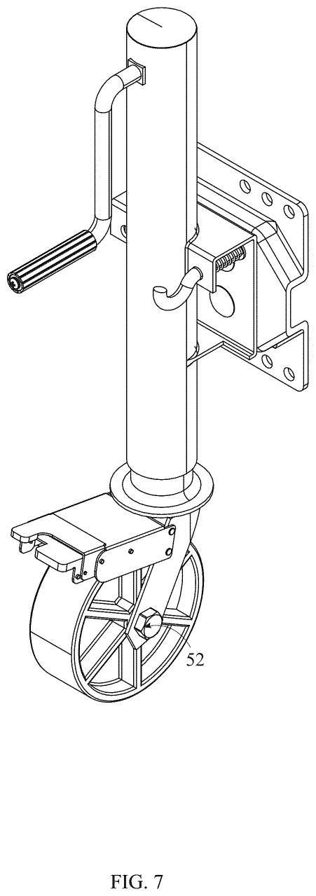

FIG. 8 is a front view of the invention.

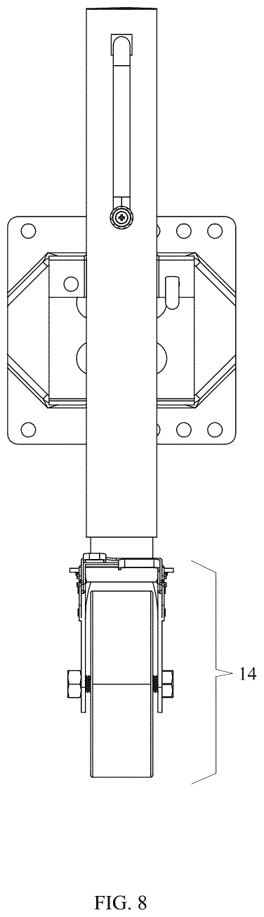

FIG. 9 is a rear view of the locking wheel.

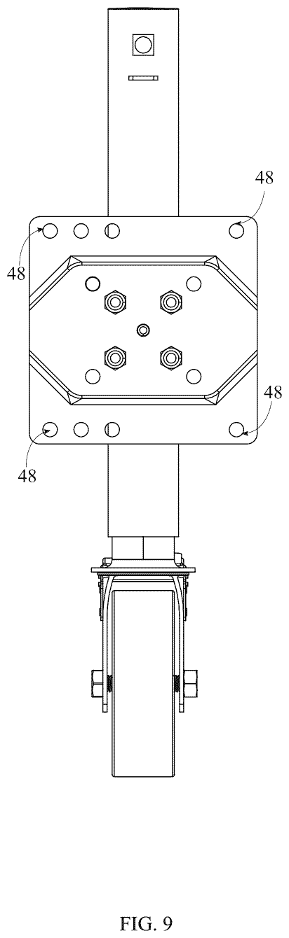

FIG. 10 is a front-bottom-right view of the locking wheel locked.

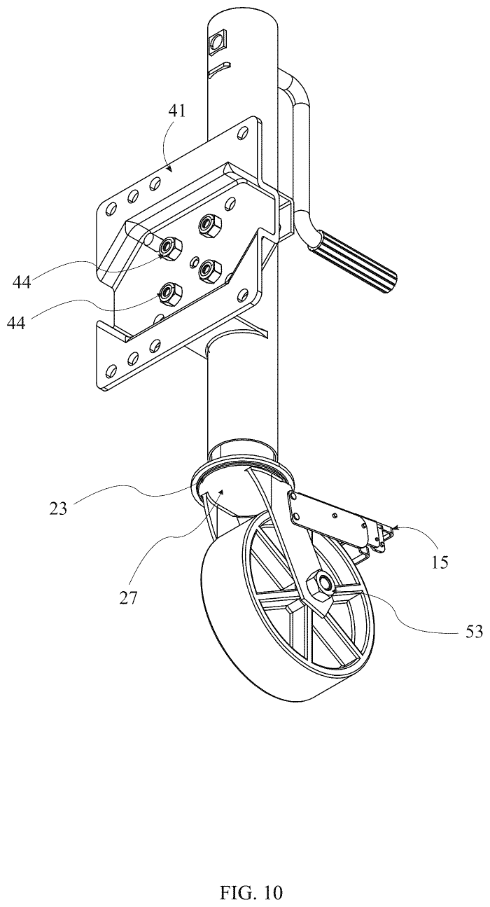

FIG. 11 is a left view of the wheel assembly showing the ball bearings.

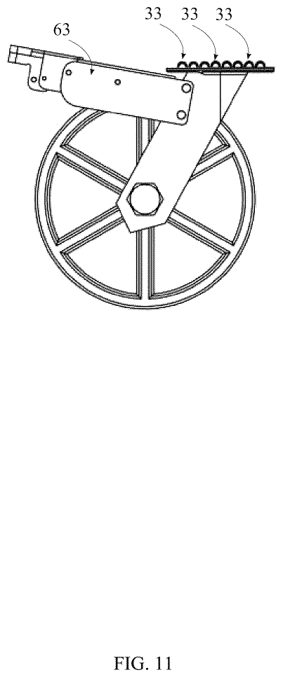

FIG. 12 is a front view of the invention with the wheel removed to show the focal screw.

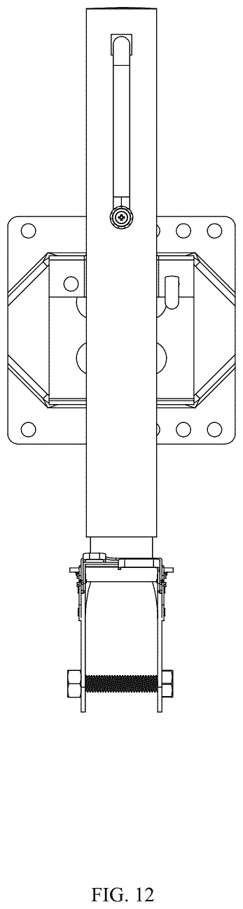

FIG. 13 is a front view of one of the securement panels

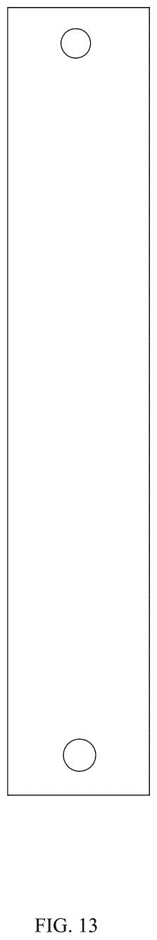

FIG. 14 is an isometic view of one of the securement panels.

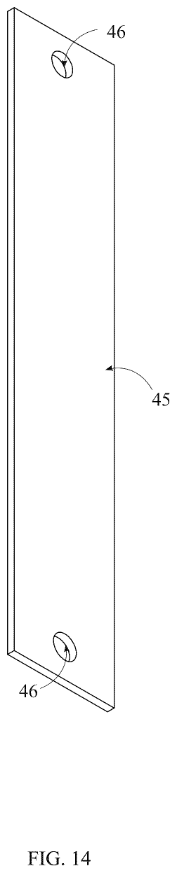

FIG. 15 is a view of the swivel jack attached an item being pulled.

FIG. 16 is a view of the wheel assembly with the wheel removed.

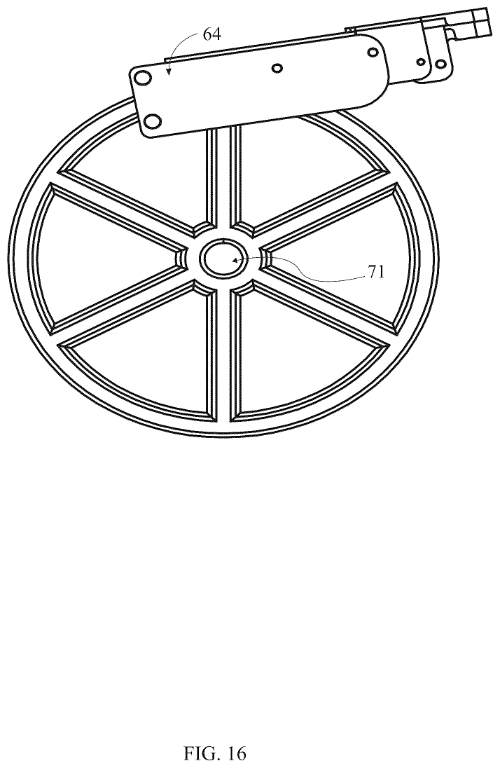

### DETAIL DESCRIPTIONS OF THE INVENTION

All illustrations of the drawings are for the purpose of describing selected versions of the present invention and are not intended to limit the scope of the present invention.

Jacks are often used to hoist trailers when they are not being pulled. The present invention is a swivel jack. The swivel jack has a mechanism that allows the trailer jack to be “swivel” in any direction. The present invention is used for raising and lowering a trailer. The swivel jack comprises a central element 11, a crank 12, an attachment unit 13, a wheel assembly 14, and a foot pedal 15. The central element 11 is the main structural unit of the invention and comprises an internal column 21 and an external column 22. The external column 22 has an upper quadrant 26. The internal column 21 is smaller in diameter than the external column 22. This is necessary as the internal column 21 is telescopically positioned inside the external column 22. The crank 12 is positioned about the upper quadrant 26 of the external column 22. The crank 12 comprises an arm handle 31 and a grip 32. The arm handle 31 is typically formed of any bent shape at a 90 degree angle. This provides optimum leverage so one can “crank” the jack higher or lower. A grip 32 is slidably attached to the arm handle. The grip 32 provides added traction so one's hand does not slip and slide about as they turn the arm handle 31 of the crank.

The central element 11 further comprising a base 23, a plate 24, and a stabilizing member 28. The base 23 has an underside 27. The lower quadrant 25 of the internal column 21 is centrally fused to the plate 24. The plate 24 being is located on top of the base 23. A stabilizing member 28 is perimetrically positioned around the lower quadrant 25 of the internal column 21 where it fuses to the plate 24. The stabilizing member 28 is a ring that provides stability to the internal column 21 on the plate 24. The base 23 does not lay entirely flush with the plate 24 and in fact it forms a cavity between it and the plate 24. A plurality of ball bearings 33 are housed between the plate 24 and the base 23. These ball bearings 33 are the mechanism that allows the jack to swivel.

The attachment unit 13 further comprises an external panel 41 and an internal panel 42. The external panel 41 is attached to the internal panel 42 by way a plurality of attachment screws. The attachment unit 13 further comprises a plurality of attachment nuts and each of the plurality of attachment nuts are threadedly attached to the plurality of attachment screws. With the plurality of attachment nuts in place, it ensures that the external panel 41 and internal panel 42 do not become separated.

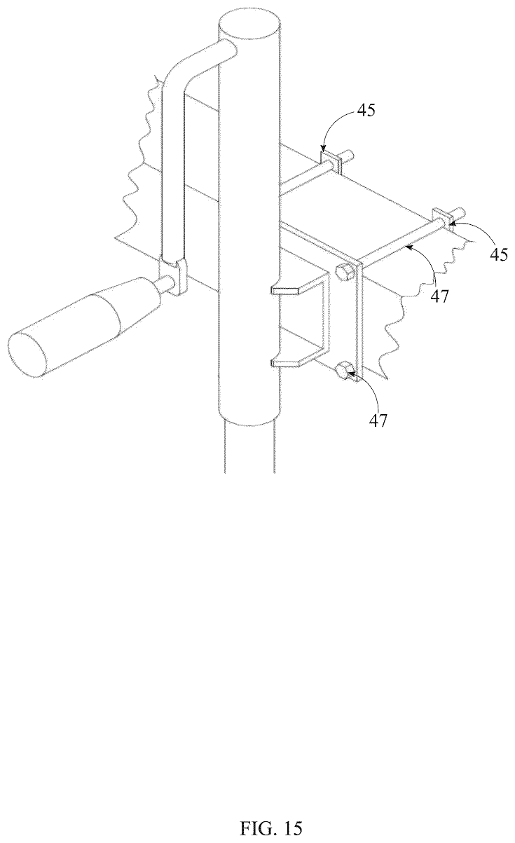

The external panel 41 comprising a plurality of apertures 48. The plurality of apertures 48 being perimetrically positioned about the external panel 41, however, in the preferred embodiment, each of the plurality of apertures 48 are located in one of the corners of the external panel 41. The attachment unit 13 further comprises a plurality of securement panels 45 and a plurality of securement screws 43. The plurality of securement panels 45 are one inch by four inch panels that are placed on the outside of the trailer being pulled as shown in FIG. 15. Each of the plurality of securement panels 45 comprises a plurality of securement apertures 46. Each of the plurality of securement screws 43 traverse through one of the plurality of apertures 48 of the external panel 41 and one of the plurality of securement apertures 46 of the securement panel 45 thereby holding the trailer in place as shown in FIG. 15.

The wheel assembly 14 comprises a wheel 51, a first support appendage 54, a second support appendage 55. The wheel 51 is circular in shape comprises a focal aperture 71. The focal aperture 71 is centrally located on the wheel 51 and traverses through the centrer of the wheel. A focal screw 52 is also present. The support appendages are arm like structures that extend outward at an angle from the center point of the wheel 51 and attach the wheel assembly 14 to the central element 11. The first support appendage 54 has a proximal end 56 and a distal end 57. The second support appendage 55 also has a proximal end 58 and a distal end 59. The proximal end 56 of the first support appendage 54 is angularly fused to the underside 27 of the base 23. The proximal end 58 of the second support appendage 55 is also angularly fused to the underside 27 of the base 23. The focal screw 52 traverses through the distal end 57 of the first support appendage 54, the distal end 59 of the second support appendage 55, and the focal aperture 71. This configuration ensures that the wheel 51 remains attached to the wheel assembly 14. A focal nut 53 is threadedly connected to the focal screw 52 to ensure that the focal screw does not come loose.

The swivel jack is equipped a lock feature that locks the wheel 51 into a stationary position so that the trailer does not roll out of its intended spot. The foot pedal 15 comprises a top surface 61, a left boundary 63, and a right boundary 64. The top surface 61 is positioned between the left boundary 63 and the right boundary 64. The top surface 61 has an exposed edge 66. The exposed edge 66 is the edge the faces out from the central element 11. The left boundary 63 is fixedly attached to the proximal end 56 of the first support appendage 54. The right boundary 64 being fixedly attached to the proximal end 58 of the second support appendage 55. The swivel jack further discloses a braking lever 65. The braking lever 65 is hingedly connected to the exposed edge 66 of the top surface 61. When one desires to lock the jack, they depress the braking lever 65 and the braking lever 64 is lowered on to the top surface 61 of the wheel 51 preventing the wheel 51 from turning. In order to release the break, the braking lever 65 is lifted allowing the wheel to rotate.

Although the invention has been explained in relation to its preferred embodiment, it is to be understood that many other possible modifications and variations can be made without departing from the spirit and scope of the invention.

What is claimed is:

1. A swivel jack comprising:
a central element;
a crank;
an attachment unit;
a wheel assembly;
a foot pedal;
the wheel assembly comprising a wheel, a first support appendage, a second support appendage;
the central element comprising an internal column and an external column;
the external column having an upper quadrant;
the crank being positioned about the upper quadrant of the external column; and
the crank comprising an arm handle and a grip.

2. The swivel jack as in claim 1:
the internal column being smaller in diameter than the external column; and
the internal column being telescopically positioned inside the external column.

3. The swivel jack as in claim 1 comprising:
the grip being slidably attached to the arm handle;
the central element further comprising a base, a plate, and a stabilizing member;
the lower quadrant of the internal column being centrally fused to the plate;
the plate being centrally located on top of the base;
the base having an underside;
a plurality of ball bearings being housed between the plate and the base; and
a stabilizing member being perimetrically positioned around the internal column where it fuses to the plate.

4. The swivel jack as in claim 1 comprising:
the attachment unit comprising an external panel and an internal panel;
the external panel being attached to the internal panel by way a plurality of attachment screws;
a plurality of attachment nuts; and
each of the plurality of attachment nuts being threadedly attached to the plurality of attachment screws.

5. The swivel jack as in claim 4 comprising:
the external panel comprising a plurality of apertures;
the plurality of apertures being perimetrically positioned about the external panel;
a plurality of securement panels;
a plurality of securement screws
the plurality of securement panels comprising a plurality of securement apertures; and
each of the plurality of securement screws traversing through one of the plurality of apertures of the external panel and one of the plurality of securement apertures of the securement panel.

6. The swivel jack as in claim 1 comprising:
the wheel comprising a focal aperture; and
a focal screw;

7. The swivel jack as in claim 1 comprising
the wheel being circular in shape; and
the focal aperture being centrally located on the wheel.

8. The swivel jack as in claim 6 comprising:
the first support appendage having a proximal end and a distal end;
the second support appendage having a proximal end a distal end;
the proximal end of the first support appendage being angularly fused to the underside of the base
the proximal end of the second support appendage being angularly fused to the underside of the base;
the focal screw traversing through the distal end of the first support appendage, the distal end of the second support appendage, and the focal aperture;
a focal nut being threadedly connected to the focal screw.

9. The swivel jack as in claim 1 comprising:
the foot pedal comprising a top surface, a left boundary, and a right boundary;
the top surface having an exposed edge;
the top surface being positioned between he left boundary and the right boundary;

10. The swivel jack as in claim 9 comprising:
the left boundary being fixedly attached to the proximal end of the first support appendage;
the second boundary being fixedly attached to the proximal end of the second support appendage; and
a braking lever being hingedly connected to the exposed edge of the top surface.

11. A swivel jack comprising:
a central element;
a crank;
an attachment unit;
a wheel assembly;
a foot pedal;
the wheel assembly comprising a wheel, a first support appendage, a second support appendage;
the central element comprising an internal column and an external column;
the external column having an upper quadrant;
the crank being positioned about the upper quadrant of the external column;
the crank comprising an arm handle and a grip;
the internal column being smaller in diameter than the external column; and
the internal column being telescopically positioned inside the external column.

12. The swivel jack as in claim 11 comprising:
the grip being slidably attached to the arm handle;
the central element further comprising a base, a plate, and a stabilizing member;
the lower quadrant of the internal column being centrally fused to the plate;
the plate being centrally located on top of the base;
the base having an underside;
a plurality of ball bearings being housed between the plate and the base; and
a stabilizing member being perimetrically positioned around the internal column where it fuses to the plate;
the attachment unit comprising an external panel and an internal panel;
the external panel being attached to the internal panel by way a plurality of attachment screws;
a plurality of attachment nuts; and
each of the plurality of attachment nuts being threadedly attached to the plurality of attachment screws.

13. The swivel jack as in claim 12 comprising:
the external panel comprising a plurality of apertures;
the plurality of apertures being perimetrically positioned about the external panel;
a plurality of securement panels;
a plurality of securement screws
the plurality of securement panels comprising a plurality of securement apertures; and
each of the plurality of securement screws traversing through one of the plurality of apertures of the external panel and one of the plurality of securement apertures of the securement panel;
the wheel being circular in shape; and

14. The swivel jack as in claim 11 comprising
a focal screw;
the focal aperture being centrally located on the wheel.

15. The swivel jack as in claim 14 comprising
The wheel comprising a focal aperture;
the first support appendage having a proximal end and a distal end;
the second support appendage having a proximal end a distal end;
the proximal end of the first support appendage being angularly fused to the underside of the base
the proximal end of the second support appendage being angularly fused to the underside of the base;
the focal screw traversing through the distal end of the first support appendage, the distal end of the second support appendage, and the focal aperture;
a focal nut being threadedly connected to the focal screw.

16. The swivel jack as in claim 11 comprising:
the foot pedal comprising a top surface, a left boundary, and a right boundary;
the top surface having an exposed edge;
the top surface being positioned between he left boundary and the right boundary;
the left boundary being fixedly attached to the proximal end of the first support appendage;
the second boundary being fixedly attached to the proximal end of the second support appendage; and
a braking lever being hingedly connected to the exposed edge of the top surface.
